(19) United States
(12) Patent Application Publication
(10) Pub. No.: US 2012/0165428 A1
(43) Pub. Date: Jun. 28, 2012

(54) Polymer for Extending the Open Time of Waterborne Architectural Coatings

(75) Inventors: Navin Tilara, Roseland, NJ (US); Hrire Gharapetian, Ridgewood, NJ (US); David L. Siegfried, Longhorne, PA (US); Robert Sheerin, North Caldwell, NJ (US)

(73) Assignee: Columbia Insurance Company, Omaha, NE (US)

(21) Appl. No.: 12/977,985

(22) Filed: Dec. 23, 2010

(51) Int. Cl. C08L 33/26; C08L 63/00

(52) U.S. Cl. 523/400; 524/555

(57) ABSTRACT

The present invention relates to water soluble open time extenders, which are mixed with an architectural coating, such as aqueous latex paints, to increase the coating's open time and crosslink to the architectural coating upon drying. The open time extender comprises neutralized water soluble polymers with hydrophobic, hydrophilic and cross-linkable monomers, and at least one crosslinking agent. The open time extender also comprises water and the total solid content of the open time extender is less than about 25% by weight.

### FIELD OF THE INVENTION

The present invention relates to a water soluble open time extender comprised of a polymer having hydrophobic, hydrophilic and crosslinking monomers. The water soluble open time extender can be used as an additive for extending the open time of aqueous coatings, thereby improving flow and leveling. Upon drying, the water soluble open time extender further crosslinks with the aqueous coating so as to preserve the dry film properties of the aqueous coating.

### BACKGROUND OF THE INVENTION

In response to environmental regulations limiting the level of volatile organic compounds (VOCs) in paint compositions, low VOC aqueous paints have been developed as an alternative to environmentally unfriendly VOC solvent-based paints. However, these new low VOC paints do not exhibit the same characteristics as the traditional paints given the reduced use of solvents and newer emulsions. In particular, the low VOC paints dry faster, have shorter open time, and poorer flow and leveling. Open time is the time interval during which freshly applied paint can be blended with subsequently applied paint without the appearance of lack of uniformity. The reduced open time of these low VOC paints has frustrated painters, professionals and DIYers alike. Open time problems include, but are not limited to, skinning of left-open paints, not being able to cut back or blend in during brushing and rolling, and non-uniformity of sprayed surfaces. These problems are further exacerbated under fast dry conditions such as low humidity and high temperature.

Some attempts to extend the open time of architectural coatings have involved modifying the aqueous paint composition itself during the manufacturing process. For example, U.S. Pat. No. 7,569,636 to Tennebroek et al. discloses an aqueous coating composition with an improved open time. The composition comprises, among other things, a crosslinkable oligomer that provides improved open time and a dispersed polymer (e.g., in the form of a polymer latex) that reduces time to tack free dryness of the composition.

U.S. Pat. No. 6,040,368 to Mayer et al. discloses an aqueous coating composition comprising an emulsion polymer that includes a copolymerized ethylenically unsaturated monomer such as acetoacetoxyethyl methacrylate (AAEM) with an improved open time.

U.S. Pat. No. 6,610,776 to Laubender et al. discloses aqueous high gloss emulsion paints that incorporate an emulsion copolymer which exhibit a long open time.

Another method of improving open time involves the use of a paint extender, which a consumer can add to a pre-manufactured aqueous paint. One latex-based paint extender on the market is Floetrol®, which is commercially available from the Flood Company of Hudson, Ohio. However, when Floetrol® is added to paints, the aqueous paints still tend to form skins, which are indicative of poor open time. Floetrol® also negatively affects water sensitivity and paint flow leveling. Furthermore, Floetrol® has poor compatibility with many commercial low-VOC latex paints and often causes syneresis and separation. Floetrol® also reduces the gloss of higher sheen paints, such as semigloss and high gloss paints. Additionally, WONDERWET™, sold by Morgan Polymer Associates of Rancho Mirage, Calif., is an open time extender available that is added to the paint during manufacturing. However, paints it is added to suffer from less than ideal dry film properties, including reduced scrubs and decreased water resistance.

US 2007/0249780 to Bakeev et al. concerns a stabilizer composition comprising an uncrosslinked AB type polymer for use in increasing open time of an aqueous coating composition.

Some of the prior art references also relate to the use of the polyurethane. U.S. Pat. No. 6,303,189 to Gray et al. discloses the addition of an aqueous polyurethane dispersion (PUD) to an aqueous coating composition having at least one film forming latex polymer to extend the open time of the coating. However, Gray does not disclose the use of crosslinking monomers within the PUD and notes that the latex polymer is substantially un-crosslinked. US 2006/0148980 to Tielemans et al., concerns polyurethane and polyurethane/acrylic hybrid dispersions formed from functional polyurethane and vinyl monomers including crosslinking agents to enhance the film formation and fast hardness development of the polyurethane. Tielemans discloses the use of the vinyl monomers with functional groups that can crosslink with the polyurethane to decrease the minimum film forming temperature of the polyurethane without undermining the hardness of the polyurethane. Although Tielmans discloses the case of polyurethane/acrylic hybrid dispersions, such dispersions may have compatibility problems which result in syneresis and separation. Further, if the polyurethane is especially hard, the paint may need more coalescent, or if it is too soft, the paint will have blocking problems.

Co-pending application US 2009/0227705 to Bochnick et al., which is incorporated herein by reference in its entirety, concerns a latex open time extender wherein the acrylic or vinyl latex particles comprising the extender are sequentially polymerized hydrophilic and crosslinking monomers. Also, the latex particles are less than about 150 nm in size.

There still remains a need for a water soluble open time extender for low-VOC aqueous paints with suitable dry film properties.

### SUMMARY OF THE INVENTION

The current invention relates to a water soluble open time extender adapted to be admixed with an architectural coating composition to extend the open time of said architectural coating composition. The open time extender includes neutralized water soluble polymers comprised of hydrophilic, hydrophobic and crosslinking monomers, wherein the crosslinking monomer is selected to be cross-linkable with the polymer it is incorporated into, other open time polymers containing crosslinkable monomers, or the architectural coating composition; at least one crosslinking agent; and water. The total solid content of the open time extender is less than about 20% by weight.

In a further embodiment of the open time extender, the hydrophilic monomer is selected from a group consisting of acrylic acid (AA), methacrylic acid (MAA), itaconic acid (IA), hydroxyethyl acrylate (HEA), hydroxyethyl methacrylate, (HEMA), acetoacetoxyethyl methacrylate (AAEM), diacetone acrylamide (DAAM), vinyl acetate (VA), or copolymers and combinations thereof. In a preferred embodiment, the hydrophilic monomer is acrylic acid (AA). In a more preferred embodiment, the hydrophilic monomers are acrylic acid (AA) and diacetone acrylamide (DAAM).

Additionally, in certain embodiments of the current open time extender, the hydrophobic monomer may be selected from a group consisting of vinyl 2-ethylhexanoate, vinyl laurate, vinyl stearate, vinyl alkyl or aryl ethers with (C₉-C₃₀) alkyl groups such as stearyl vinyl ether; (C₄-C₃₀) alkyl esters of (meth-)acrylic acid, such as butyl(meth)acrylate, hexyl(meth)acrylate, heptyl(meth)acrylate, octyl(meth)acrylate, isooctyl acrylate, isononyl acrylate, decyl(meth)acrylate, isodecyl(meth)acrylate, dodecyl(meth)acrylate, 2-ethylhexyl(meth)acrylate, benzyl(meth)acrylate, lauryl(meth)acrylate, oleyl(meth)acrylate, palmityl(meth)acrylate, and stearyl(meth)acrylate; unsaturated vinyl esters of (meth)acrylic acid such as those derived from fatty acids and fatty alcohols; monomers derived from cholesterol; olefinic monomers such as 1-butene, 2-butene, 1-pentene, 1-hexene, 1-octene, isobutylene and isoprene; or copolymers and combinations thereof. In particular, methyl methacrylate, a slightly hydrophobic monomer, may be used within the open time extender in conjunction with monomer having greater hydrophobicity,

Further, in other embodiments of the current invention, the cross-linkable monomer may be selected from the group consisting of diacetone acrylamide (DAAM), monoalkoxydialkyl vinyl silanes, dialkoxyalkyl vinyl silanes, trialkoxy vinyl silanes, monoalkoxy acrylic silanes, dialkoxy acrylic silanes, trialkoxy acrylic silanes, trialkoxy methacrylic silanes, monoalkoxy epoxy silanes, dialkoxy epoxy silanes or trialkoxy epoxy silanes, and copolymers and combinations thereof. Preferably, the at least one cross-linkable monomer can crosslink to the polymer containing itself, to other open time polymers containing cross-linkable monomers, to the architectural coating composition, including a latex in the architectural coating or any additives to the architectural coating, or any combination thereof at ambient conditions. Additionally, in certain embodiments of the open time extender, the crosslinking agent may have at least one cross-linkable functional group selected from the group consisting of epoxies, silanes, silane ethers, amines, hydroxyls, carboxylic acids, carboxylates, amides, urethanes, thiourethanes, ureas, thioureas, isocyanates, isothiocyanates, acid halides, aldehydes, anhydrides, and combinations thereof. In a preferred embodiment, the cross linking agent is adipic dihydrazide (ADH).

In a further embodiment of the current invention, the open time extender is neutralized with ammonium hydroxide. Also, the water soluble polymers of the open time extender of the current invention may also be neutralized in situ when they are added to the architectural coating.

In yet another embodiment of the current invention, the neutralized water soluble polymer comprises total solid content of the open time extender is less than about 25%, preferably is less than about 20%, and most preferably is less than about 17%.

The open time extender of the current invention may be added to an architectural coating composition, and the architectural coating is preferably a paint composition. In the embodiments where the open time extender is added to an architectural coating, the open time extender should be less than 10% weight of the architectural coating composition, preferably less than 7.5% weight of the architectural coating composition, and most preferably less than 5% weight of the architectural coating composition.

In one embodiment of the current invention, the open time extender has a weight average molecular weight of less than about 25,000 Daltons, preferably less than about 20,000 Daltons, and most preferably about 11,000 Daltons. Additionally, in certain embodiments, the open time extender has a weight average molecular weight of between about 5,000 Daltons to about 15,000 Daltons. Alternatively, in certain embodiments, the open time extender has a numerical average molecular weight of less than 10,000 Daltons, preferably less than about 7,500 Daltons. Additionally, the numerical average molecular weight of the open time extender of the current invention may be between about 3,000 to about 6,000 Daltons. Also, the open time extender may have a polydispersity index of less than 5 and preferably less than 4.

The open time extender may further include at least one of an open time agent, pH adjustor, a second crosslinking agent having at least one cross-linkable functional group, a preservative, a biocide and a defoamer.

### DETAILED DESCRIPTION OF THE INVENTION

The present invention concerns water soluble/water dispersible open time extenders, additives which are admixed with aqueous coatings in order to slow down the drying process of the aqueous coatings thereby prolonging their open time. The principle component of such water soluble open time extenders is water soluble open time-enhancing polymers synthesized from hydrophobic, hydrophilic and crosslinking monomers. Advantageously, the hydrophilic monomers are believed to form hydrogen bonds with water molecules in aqueous paints, thereby prolonging open time without using environmentally unfriendly volatile organic compounds (VOCs). A further advantage is provided by the cross-linkable monomers which permit the open-time extender to link to the latex film formed by the paint when the water evaporates. Thus, the open time extender does not form a separate film that may disrupt the dry film properties of the paint, but maintains the dry film properties of the aqueous paints, such as preventing water sensitivity and color transfer. Further, and without being bound to any particular theory, the open-time extenders of the current invention also enhance the film formation of the paint. The open time extender is suitable for addition to low VOC or zero VOC paints having a variety of finishes such as high gloss, semi-gloss, satin, eggshell and flat.

As used herein the terms “paint extender” and “open time extender” mean any material added to an architectural composition, such as a latex composition or a paint, preferably an aqueous paint, to slow its drying time, vary its transparency, allow for more even strokes, or to modify any other desired property. A paint extender, such as Fleotrol™, is added just prior to application of the paint to a substrate or a surface. An open time extender such as the present invention or commercially available Wonderwet™ is added during the manufacturing process. Conventionally, the quick drying nature of aqueous paints has been addressed by adding water-soluble solvents, e.g. polyethylene glycol or polypropylene glycol, to such aqueous paints in order to improve open time. However, the addition of such volatile organic compounds (VOC) negates the advantageous features of aqueous paints such as low tack, low odor, and low pollution. The present invention is an advance over the existing art because the paint extenders developed herein can be added to aqueous paints in order to improve open time and maintain dry film properties without using any VOC.

VOC is defined according to U.S. Environmental Protection Agency (EPA) Method 24. “Low-VOC” compositions and components can have a VOC content of not more than about 250 g/L (about 25% w/v), preferably not more than about 150 g/L (about 15% w/v), more preferably not more than about 100 g/L (about 10% w/v), most preferably not more than about 50 g/L (about 5% w/v), for example not more than about 30 g/L (about 3% w/v) or not more than about 20 g/L (about 2% w/v).

“Zero-VOC” compositions can also be part of the low-VOC compositions of this invention. Zero-VOC compositions can advantageously have a VOC content of not more than about 10 g/L (about 1% w/v), preferably not more than about 8 g/L (about 0.8% w/v), more preferably not more than about 5 g/L (about 0.5% w/v), for example not more than about 2 g/L (about 0.2% w/v).

The water soluble paint or open time extenders used herein are synthesized from hydrophobic, hydrophilic and crosslinking monomers. Hydrophobic monomers suitable for the water soluble open time-enhancing polymers include vinyl 2-ethylhexanoate, vinyl laurate, vinyl stearate, vinyl alkyl or aryl ethers with (C₉-C₃₀) alkyl groups such as stearyl vinyl ether; (C₄-C₃₀) alkyl esters of (meth-)acrylic acid, such as butyl(meth)acrylate, hexyl(meth)acrylate, heptyl(meth)acrylate, octyl(meth)acrylate, isooctyl acrylate, isononyl acrylate, decyl(meth)acrylate, isodecyl(meth)acrylate, dodecyl(meth)acrylate, 2-ethylhexyl(meth)acrylate, benzyl(meth)acrylate, lauryl(meth)acrylate, oleyl(meth)acrylate, palmityl(meth)acrylate, and stearyl(meth)acrylate; unsaturated vinyl esters of (meth)acrylic acid such as those derived from fatty acids and fatty alcohols; monomers derived from cholesterol; olefinic monomers such as 1-butene, 2-butene, 1-pentene, 1-hexene, 1-octene, isobutylene and isoprene; and the like, and copolymers or combinations thereof. Generally, the open time extender of the present invention may contain up to about 40% WT of constituent monomers with hydrophilic functionalities. Preferably, the open time extender may have about 10-40% WT of constituent monomers with hydrophobic functionalities, and more preferably about 15-35% WT of constituent monomers with hydrophobic functionalities.

Methyl methacrylate, a slightly hydrophobic monomer, may be used in addition to the hydrophobic monomers noted above. In general, methyl methacrylate aids in the compatibility and processing of the various monomers of the current open-time extender. Methyl methacrylate may be present in the open time extender in amount up to about 60% WT of the open time extender. Preferably, the open time extender may contain about 10-60% WT and more preferably about 30-60% WT of methyl methacrylate.

Hydrophilic monomers suitable for the water soluble open time-enhancing polymers of the current invention preferably include hydrophilic monomers having acid functionality. Hydrophilic monomers suitable for the current water soluble open time extenders include, but are not limited to, acrylic acid (AA), methacrylic acid (MAA), itaconic acid (IA), hydroxyethyl acrylate (HEA), hydroxyethyl methacrylate, (HEMA), acetoacetoxyethyl methacrylate (AAEM), diacetone acrylamide (DAAM), vinyl acetate (VA) and the like, and copolymers and combinations thereof. By using these hydrophilic monomers, the inventive water soluble open time extenders and, therefore, the paints that include the inventive water soluble open time extenders, have improved capability to hold water. Without being bound by any particular theory, it is believed that such hydrophilic monomers slow down the evaporation of water by forming hydrogen bonds with water, thus prolonging the duration of an aqueous paint's open time. Generally, the open time extender contains about 20-40% WT of constituent monomers with hydrophilic functionalities.

In addition to the hydrophobic and hydrophilic monomers noted above, the water soluble open time-enhancing polymers also advantageously comprise at least one cross-linkable monomer or oxidatively crosslinkable monomer that crosslinks with itself and/or the architectural coating composition, i.e. the latex and/or additives to the coating composition as detailed below, at ambient conditions, thus helping to maintain an aqueous paint's dry film properties. Other examples include, but are not limited to, monoalkoxydialkyl vinyl silanes, dialkoxyalkyl vinyl silanes, trialkoxy vinyl silanes, monoalkoxy acrylic silanes, dialkoxy acrylic silanes, trialkoxy acrylic silanes, trialkoxy methacrylic silanes, monoalkoxy epoxy silanes, dialkoxy epoxy silanes or trialkoxy epoxy silanes, and the like, and copolymers and combinations thereof. Although the crosslinkable monomers may be hydrophobic, neutral, or hydrophilic, the crosslinkable monomers are preferably hydrophilic. DAAM, which was mentioned above as a hydrophilic monomer, is an example of one such hydrophilic crosslinkable monomer. In one embodiment, the latex particle can have a crosslinkable monomer content in the range of about 0.01 to 20 WT %, preferably from about 0.02 to 15 WT %, more preferably from about 0.05 to 10 WT %, most preferably from about 0.1 to 8 WT %.

The cross-linkable monomer(s) or oxidatively crosslinkable monomer(s) can crosslink to the polymer containing itself, to other open time polymers containing cross-linkable monomers in the extender, and/or to the architectural coating composition at ambient conditions. With regard to the architectural coating, the crosslinkable monomer(s) can cross link with the latex of the architectural coating or with various additives to the architectural coating including, but not limited to additional open time agents, dispersants, coalescents, thickeners or rheology modifiers, freeze-thaw additives, humectants, wetting agents, colorants, waxes, or defoamers if they possess cross-linkable functionality.

The open time extenders of the current invention are preferably substantially acrylic, and preferably solely acrylic. In a further embodiment of the present invention, the water soluble open time extenders are substantially free of urethanes, and in particular polyurethanes.

The water soluble open time-enhancing polymers of the open time extender described herein may be prepared using polymerization techniques well known in the art, although emulsion polymerization is generally preferred. In the preparation of emulsion polymers, conventional surfactants may be used. Examples of surfactants useful in the preparation of the emulsion according to the invention can include, but are not limited to, nonionic and/or anionic surfactants such as anionic and/or nonionic emulsifiers such as alkali or ammonium alkyl sulfates, alkyl sulfonic acids, fatty acids, oxyethylated alkyl phenols, ammonium nonoxynol-4 sulfate, nonylphenol ethoxylate(10), octylphenol ethoxylate(9-10), sodium dodecylbenzene sulfonate, sodium dodecyl sulfonate, sodium tetradecyl sulfonate, sodium hexadecyl sulfonate, sodium lauryl sulfate those sold under the tradename Triton™ (e.g., QS series, CF series, X series, and the like), those sold under the tradename Igepal™, those sold under the tradename Rhodapon™, such as R610, LSB, and LCP, those sold under the tradename Rhodapex™, such as CO 436, LA-401s, and LA 300 SB, those sold under the tradename Rhodafac™, such as PE-510, RA-600E, and LO 529, those sold under the tradename Rhodacal™, such as A246, DS-4, and DSB, and the like, Rhodasurf BC-729 and combinations thereof.

Either thermal or redox initiation processes may be used to initiate the polymerization. Conventional free radical initiators may be used such as, for example, hydrogen peroxide, t-butyl hydroperoxide, and ammonium, sodium, or alkali persulfates. Further, the size (average molecular weight) of the resulting polymers can be controlled through the addition of chain transfer agents to limit the size of the polymer. Suitable chain transfer agents include, but are not limited to, halogenated hydrocarbons (halomethanes, chloroform, carbon tetrachloride, carbon tetrabromide, and bromotrichloromethane), thiols (mercapatol, methylthioglycol, and isooctyl 2-mercaptopropionate), aromatic mercaptans, long chain alkylmercaptans, or disulfides. Finally, a chaser solution of a reducing agent and/or oxidizing agents, such as the free radical initiators noted above, can be used to terminate the reaction. Suitable reducing agents for the synthesis of the current open-time extender include, but are not limited to, sodium formaldehyde sulfoxylate (SFS), sodium hydrosulfite, sodium dithionite, and sodium salts of organic sulfinic acid derivatives. Suitable reducing agents are available from Bruggemann Chemical U.S., Inc. of Newtown Square, Pa. under the tradename Bruggolite®. An example of an emulsion polymerization in accordance with the current invention is provided in Example 1, below.

The polymeric particles should have a weight average molecular weight of less than about 25,000 Daltons, preferably less than about 20,000 Daltons, more preferably less than about 15,000 Daltons, and most preferably about 11,000 Daltons. Alternatively, the weight average molecular weight of the polymeric particles may be about 1,000 to 25,000 Daltons, preferably about 2,500 to about 20,000 Daltons, and most preferably about 4,000 to about 15,000 Daltons. Additionally, the number average molecular weight of the polymeric particles may be less than about 10,000 Daltons, preferably less than about 7,500 Daltons, and most preferably about 5,000 Daltons. Alternatively, the number average molecular weight of the polymeric particles may be about 1,000 to 10,000 Daltons, preferably about 2,000 to 8,000 Daltons, and most preferably about 3,000 to 6,000 Daltons. The polydispersity index (PDI) for the polymeric particles of the current invention is less than or equal to about 10, less than or equal to about 7.5, less than or equal to about 5, or less than or equal to about 4.

The open time-enhancing polymer formed by the above processes may then be neutralized by various basic pH adjustors including, but not limited to, ammonium hydroxide, sodium hydroxide, sodium carbonate, sodium bicarbonate, potassium hydroxide, potassium carbonate, potassium bicarbonate, ammonium salts, ammonia, amines, aminoalcohols (e.g., 2-amino-2-methyl-1-propanol and/or those compounds sold under the tradename AMP™ 95 by Angus Chemical Company of Buffalo Grove, Ill.), and the like, and combinations thereof. Preferred pH adjustors include ammonia, amines and aminoalcohols. Preferably, the pH adjustor is ammonium hydroxide or sodium hydroxide, and most preferably is ammonium hydroxide. Ammonium hydroxide is a preferred neutralizer as it tends to dissipate and does not persist in the polymer to the same extent as other neutralizing agents and, thus, will not interfere with the properties of the resulting water soluble open time-enhancing polymer or the paint to which the open time enhancer may eventually be added.

In an alternative embodiment, the resulting open time-enhancing polymer may be neutralized by adding it directly to the paint and neutralizing it in situ while making the paint.

Once the water soluble open time extender or architectural coating with open time extender has been polymerized a crosslinking agent is added to the extender or coating to render it crosslinkable. Low-VOC crosslinking agents (and crosslinking agents, in general) can typically include at least one crosslinkable functional group (and usually at least two crosslinkable functional groups) capable of reacting with a corresponding reactive (crosslinkable functional) group on another molecule. Non-limiting examples of crosslinkable functional groups include epoxies, silanes, silane ethers, amines, hydroxyls, carboxylic acids, carboxylates, amides, urethanes, thiourethanes, ureas, thioureas, isocyanates, isothiocyanates, acid halides, aldehydes, anhydrides, and the like, and combinations thereof. The low-VOC crosslinking agent may contain both a silane ether functional group and an epoxy functional group (i.e., an epoxysilane). The crosslinking agent does not include, and in some preferred embodiments specifically excludes, any compound and/or functional group that participates in, facilitates, or catalyzes oxidative crosslinking (e.g., atmospheric oxygen can cause oxidative crosslinking of pendant ethylenic unsaturations and other residual hydrocarbon double bonds). In another embodiment, the crosslinking agent does not include, and in some embodiments specifically excludes, organometallic catalysts (e.g., titanium carboxy-esters that can ester exchange with crosslinkable groups such as silanes to activate a crosslinking reaction). In a preferred embodiment, the crosslinking agent is adipic dihydrazide (ADH). In particular, ADH is capable of crosslinking the polymer chains by reacting with the diacetone acrylamide (DAAM) crosslinking groups present in the water soluble open time-enhancing polymer of the water soluble open time extender. The crosslinking of the polymers synergistically helps prevent water sensitivity and color transfer in the architectural coating in which the water soluble open time extender is used. The low-VOC crosslinking agents in the paint or open time extenders of the invention may be in the range of about 0.01 to 20 wt %, preferably from about 0.02 to 15 wt %, more preferably from about 0.05 to 10 wt %, most preferably from about 0.1 to 8 wt %.

The resulting water soluble open time extender has a solids content of less than about 25% wt, more preferably less than about 20% wt, and most preferably less than about 17% wt. Further, when the water soluble open time extender is added to the architectural coating it should be less than about 10% wt, more preferably about 7.5% wt, and most preferably about 5% wt of the architectural coating.

The water soluble open time extenders of the current invention not only substantially increase the open time of the architectural coating or paint to which they are added, but also enhance such critical paint performance attributes as water sensitivity and color transfer. This improvement is attributable to the synergistic effect of the hydrophilic, hydrophobic and crosslinked monomers on the resultant polymer and the process steps of neutralizing the polymerization emulsion and the addition of a crosslinking agent. As noted above, once the water in the paint evaporates the water soluble open-time extender of the current invention links to the latex film formed by the paint as opposed to forming an independent film. The crosslinkable monomers of the current water soluble open time extenders are believed to crosslink with the latexes or other additives in aqueous paints during the drying process. Additionally, this crosslinking maintains the dry film properties of the aqueous paints, such as preventing water sensitivity and color transfer. Further, while not wishing to be bound to a particular theory, it is suspected that the water soluble open time extenders of the current invention may aid film formation by extending open time thereby permitting greater mobility to polymers. To a lesser extent, the open time extenders may act as a polymeric coalescent enhancing the paint's film formation.

Further, the water soluble open time extenders may be combined with other additives including, but not limited to, pH adjustors, additional open time agents, thickener, dispersant, additional cross linking agents having at least one crosslinkable functional group, a preservative, a biocide, or a defoamer to achieve a synergistic or additive effect on the paints attributes.

Examples of pH adjustors useful in the paint extender compositions according to the invention are noted above. In certain cases, compounds that qualify as pH adjustors can be added for purposes other than adjusting pH (e.g., temporary deactivation of otherwise reactive functional groups, emulsion stabilization, or the like), and yet are still characterized herein as pH adjustors.

Preferably the water soluble open time extender of the current invention is the only open time extender utilized within a paint composition, however one will appreciate that it is possible to use the current water soluble open time extender with commercially available open time agents in less preferred embodiments. The current water soluble open time extenders provide unexpected benefits to the viscosity, fluidity, flowability, re-wettability and/or brushability of an architectural coating, thus the addition of commercially available open time extenders should not detract from the benefits of the current invention and if possible should synergistically add to these benefits

A representative example of a commercially available paint extender includes, but is not limited to, Floetrol® as discussed above. An example of commercial open time extenders are, those compounds sold by the Aqualon Division of Hercules, Inc. of Wilmington, Del. under the tradename OPTIMA D-4023 and those compounds sold by Morgan Polymer Associates of Rancho Mirage, Calif. under the tradename WONDERWET™, and the like, and combinations thereof.

The amount of open time agents may be in the range of about 0.01 to 10 wt %, preferably from about 0.02 to 8 wt %, more preferably from about 0.05 to 7 wt %, most preferably from about 0.1 to 5 wt % of the paint extender composition.

Preservatives and biocides may be added to the inventive composition of the current invention to prevent the growth of molds, bacteria, etc. both within the can (liquid paint) or the film (dried paint). Examples of such preservatives or biocides useful in the paint extender compositions according to the invention can include, but are not limited to, hydroxy-functional aza-dioxabicyclo compounds such as those commercially available from ISP under the trade name Nuosept™ 95, those compounds sold under the trade name SKANE™, isothiazolones such as those sold under the trade name Kathon™ from Dow Chemical, Polyphase™ additives from Troy Corp. and the like, and combinations thereof.

Examples of defoamers useful in the paint extender compositions according to the invention can include, but are not limited to, polysiloxane-polyether copolymers such as those sold by Tego under the tradename Foamex™, those sold under the tradename BYK™, those sold under the tradename Drewplus™, those sold under the tradename Surfynol™, those sold under the tradename Foamstar®, and the like, and combinations thereof.

In addition to the adjuvants noted above, the water soluble open time extenders of the current invention, as well as the paint compositions they are incorporated into, may further include, but are not limited to, well known adjuvants, such as, surfactants, emulsifiers, coalescents, thickeners or rheology modifiers, dispersants, freeze-thaw additives, humectants, wetting agents, pigments, extenders, colorants, waxes, uv-protectants, and anti-oxidants provided that they do not adversely affect the open time extender's synergistic effect on an architectural coating's open time or dry film properties.

In addition to the surfactants noted above, surfactants suitable for use within the water soluble open time extenders of the current invention and the paint compositions they are incorporated into may also include those surfactants sold under the trade names Envirogem™ and Carbowet™, and the like, and combinations thereof.

“Coalescence solvents,” also known as “coalescence aids,” “coalescents” or “coalescing agents,” are compounds that bring together polymeric components in latex paints to form films. Coalescence aids facilitate the formation of the dried film by temporarily plasticizing, i.e. softening, the latex polymers and subsequently evaporating from the dried film. Volatile coalescence aids, such as 2,2,4-trimethyl-1,3-pentanediol monoisobutyrate (Texanol EA), butyl benzyl phthalate (BBP) and dibutyl phthalate (DBP), are contemplated by the current invention, but coalescence aids with de minimis volatile emissions, those compounds that enhance the polymers to form dried films without the accompanying odors, are preferred. Suitable coalescence aids with de minimis volatile emissions, include, but are not limited to, Optifilm Enhancer 300, Optifilm Enhancer 400, sold by Eastman Chemical Company; propylene glycol monoester of unsaturated fatty acids derived from vegetable oils such as Archer Reactive Coalescent (Archer RC™); BASF Pluracoat™ CA 120 (ES8511); Loxanol™ EFC 200 (sold by Cognis Gmbh of Monheim, Germany), dicarboxylic/tricarboxylic esters, such as trimethyl trimellitate (TMTM), tri-(2-ethylhexyl)trimellitate (TEHTM-MG), tri-(n-octyl,n-decyl) trimellitate (ATM), tri-(heptyl,nonyl)trimellitate (LTM) and n-octyl trimellitate (OTM); adipates, such as bis(2-ethylhexyl)adipate (DEHA), dimethyl adipate (DMAD), monomethyl adipate (MMAD) and dioctyl adipate (DOA); sebacates, such as dibutyl sebacate (DBS); maleates such as dibutyl maleate (DBM) and diisobutyl maleate (DIBM). Other low- or zero-VOC coalescing agents include benzoates, epoxidized vegetable oils, such as N-ethyl toluene sulfonamide, N-(2-hydroxypropyl)benzene sulfonamide and N-(n-butyl)benzene sulfonamide; organophosphates, such as tricresyl phosphate (TCP) and tributyl phosphate (TBP), triethylene glycol dihexanoate, tetraethylene glycol diheptanoate, and the like, and combinations thereof. Examples of commercial low- and zero-VOC coalescing agents are benzoate esters or alkyl benzoate esters, such as those sold under Benzoflex® and Velate®, and low molecular weight polyesters, such as those sold under Admex®.

Examples of rheology modifiers useful in the compositions according to the invention can include, but are not limited to, hydrophobically modified urethane rheology modifiers, hydrophobically modified polyether rheology modifiers, alkali swellable (or soluble) emulsions, hydrophobically modified alkali swellable (or soluble) emulsions, cellulosic or hydrophobically modified cellulosic rheology modifiers. Examples are those available from Dow Chemical under the trade name Acrysol™, such as RM-8W, RM-5000, and RM-2020 NPR, RM-5, TT-935, and Natrasol™, Natrasol Plus™ and Aquaflow™, such as NHS-300, XLS-525, and NLS-200, from Aqualon Division of Hercules Inc. of Wilmington, Del., and UCAR Polyphobe™ from Dow.

Examples of dispersants useful in the compositions according to the invention can include, but are not limited to, hydrophobic copolymers such as Tamol™ 165A and carboxylated polyelectrolyte salts such as Tamol™ 731A from Dow Chemical and the like, and combinations thereof. Tripolyphosphate salts and tetrapotassium pyrophosphate can also be used to disperse the tinting colorants and/or the non-tinting filler/base pigments(s) in the coating compositions. A suitable tripolyphosphate salt is potassium tripolyphosphate (commercially available from Innophos of Cranbury, N.J.). A suitable wax dispersant is sold under the tradename Aquacer (commercially available from BYK Additives division of Altana AG of Wessel, Germany)

While typically multiple pigments/colorants are present in end-use latexes that are to be used in paint or architectural coating applications, sometimes only a white pigment, such as a zinc oxide and/or a titanium oxide, is added in the early stages of the formation of the paint composition (e.g., in the grind composition). In such a case, any other desired pigments/colorants of various colors (including more white pigment) can optionally be added at the later stages of, or after, formation of the paint composition. Examples of pigments/colorants that can be useful in the compositions according to the invention can include, but are not limited to, carbon black, iron oxide black, iron oxide yellow, iron oxide red, iron oxide brown, organic red pigments, including quinacridone red and metallized and non-metallized azo reds (e.g., lithols, lithol rubine, toluidine red, naphthol red), phthalocyanine blue, phthalocyanine green, mono- or di-arylide yellow, benzimidazolone yellow, heterocyclic yellow, DAN orange, quinacridone magenta, quinacridone violet, and the like, and any combination thereof. These exemplary color pigments can be added as powders, but can more conveniently be added as aqueous dispersions to the compositions according to the invention.

Titanium dioxide is a good reflector of light and provides the coating compositions with improved hiding power. Suitable titanium dioxides are available under the TI-PURE® (DuPont Company, Wilmington, Del.), TIONA® (Millennium Chemicals, Maryland), TRONOX® (Tronox Incorporated, Oklahoma), TIONA® TR-90 and TRONOX® CR-826.

Useful nepheline syenite pigments are typically nodular particles. A suitable nepheline syenite is marketed under the trade name MINEX® (e.g., MINEX® 7) (Unimin Corporation, Connecticut). Other suitable non-tinting filler/base pigments include but are not limited to calcined kaolin clays marketed under the OPTIWHITE® trade name including OPTIWHITE® MX (Burgess Pigment Company, Sandersville, Ga.).

Additionally or alternately, opacifying/extender pigments can be added, e.g., to the grind composition portion of the paint composition. Such opacifying/extender pigments generally provide background color to the compositions and thus can be used to minimize colorant costs and/or modify or enhance certain properties of the coating composition (such as hiding power, abrasion resistance, washability, scrubability, absorption (or permeability into the substrate), and drying time). Examples of opacifying/extender pigments useful in the paint compositions according to the invention can include, but are not limited to, nepheline syenites, silica (silicon dioxide), silicates including without limitation talc (magnesium silicate) and clays (aluminum silicate) such as calcined kaolin clays and delaminated kaolin clays, calcium carbonate in both the ground and precipitated forms, aluminum oxide, magnesium oxide, sodium oxide, potassium oxide, barytes (barium sulfate), zinc sulfite, gypsums (i.e., hydrated calcium sulphates), micas, lithophones, wallastonites, and bismuth oxychlorides, and the like. ASP-170 is a commercial example of an extender sold by BASF Group of Florham Park, N.J. Further discussion of opacifying/extender pigments can be found in U.S. Pat. No. 6,638,998 and U.S. Patent Publication No. 2007/0116879, which are incorporated herein by reference in their entireties.

The types of finishes of the paints using the water soluble paint/open time extenders of the invention can be high gloss, semi-gloss, satin or “silk”, eggshell, or flat. The degree of shininess, or gloss, is determined by the amount of pigment present in the paint. Without any pigment, most binders will yield a high gloss finish Gloss is measured in reflectivity of the painted surface at angles of 20°, 60°, and 85° from the vertical position in accordance with ASTM D-523.

Examples of UV protectants used in these compositions can include, but are not limited to UV scavengers, UV absorbers, transparent oxides, UV protective oxides, those compounds sold by Ciba Chemical under the trade name Tinuvin™, and combinations thereof. UV scavengers can include, but are not limited to, hindered amine light stabilizers (HALS). UV absorbers can include, but are not limited to, hydroxybenzophenones, hydroxyphenylbenzotriazoles, oxalanilides, hydroxyphenyl-triazines, and the like, and combinations thereof. Transparent oxides can include, but are not limited to, transparent yellow iron oxides, transparent red iron oxides, those oxides sold by CIUPL of Mumbasa under the tradename Timbasol™ PW 895 and Timbasol™ PW 896, and the like, and combinations thereof UV-protective oxides can include, but are not limited to UV-protective zinc oxides, UV-protective cerium oxides, those oxides sold by Byk Chemie under the tradename BYK LP™ X), those oxides sold by Nyacol Nano Technologies, Inc., under the tradename Nyacol™ DP5370, and the like, and combinations thereof.

### EXAMPLES

The following Examples are merely illustrative of certain embodiments of the invention. The following Examples are not meant to limit the scope and breadth of the present invention, as recited in the appended claims.

### Example 1

### Open Time Extender

Example 1 describes the synthesis of a water soluble open time extender, Open Time Extender 1 (OT 1). Initially, the reaction flask (reactor) was purged with nitrogen. A monomer emulsion and an initiator solution, with ingredients described below in Table 1, were prepared in separate flasks. Polymerization began when the initiator solution and 2.5% of the monomer emulsion were charged to the reactor under agitation at about 80° C. The reaction was held for about 15 minutes. And then the remaining monomer emulsion was fed over a period of about 120 minutes. The reaction was held for about 30 minutes at about 80° C. The reactor contents were then cooled to about 60° C. Subsequently, two separate chaser solutions, described below in Table 1, were fed into the reactor over a period of about 30 minutes to polymerize residual monomers. The reactor contents were cooled to room temperature.

In order to neutralize the emulsion and covert it to an aqueous solution, 860 grams of the polymer were fed into a reaction containing the pH adjustor, described below in Table 1, over a period of about 30 minutes.

TABLE 1
Open Time Extender with Crosslinker - Ingredients.

| | |
|---|---|
| | Quantity |
| Ingredient | (grams) |

Aqueous Surfactant Solution

| | |
|---|---|
| deionized water | 56 |
| anionic surfactant | 2 |

Monomer Emulsion

| | |
|---|---|
| deionized water | 256 |
| anionic surfactant | 5.5 |
| acrylic acid monomer (AA) | 158 |
| methyl methacrylate monomer (MMA) | 422 |
| butyl acrylate monomer (BA) | 122 |
| Diacetone Acrylamide (DAAM) | 40 |
| isooctyl 2-mercaptopropionate (chain | 7.2 |
| transfer agent) | |

Initiator Solution

| | |
|---|---|
| deionized water | 60 |
| ammonium persulfate | 6 |

Chaser Solutions

| | |
|---|---|
| t-butyl hydroperoxide | 2 |
| deionized water | 20 |
| reducing agent | 2 |
| deionized water | 20 |

pH Adjustor

| | |
|---|---|
| ammonium hydroxide | 50 |
| deionized water | 650 |

Open Time Extender 1 of this example exhibited a weighted average molecular weight of 11,576 Daltons, a numerical average molecular weight of 5,658 and polydispersity of 2.05.
Further open time extenders, Open Time Extenders 2-5 (OT 2-5), were manufactured using the above-noted procedure and the reactants noted in Table 2 below.

TABLE 2
Open Time Extenders

| Open | | | | | | | |
|---|---|---|---|---|---|---|---|
| Time Extender | MMA | BA | DAAM | AA | MAA | Base | IOMP |
| OT 2 | 270 (37.5%) | 270 (37.5%) | 22 (3%) | 0 | 158 (22%) | NaOH | 15 (2%) |
| OT 3 | 280 (39%) | 260 (36%) | 36 (5%) | 0 | 145 (20%) | NaOH | 15 (2%) |
| OT 4 | 340 (47%) | 200 (28%) | 36 (5%) | 0 | 148 (20%) | NaOH | 15 |
| OT 5 | 211 (57%) | 61 (16.5%) | 20 (5.5%) | 79 (21%) | 0 | Ammonia OH | 3.6 |

MMA = methylmethacrylate;
BA = butylacrylate;
DAAM = dimethylaminoethylmethacrylate;
AA = acrylic acid;
MAA = methacrylic acid;
and IOMP = Isooctyl-mercaptopropionate.

### Example 2

### Open Time Improvement

Example 2 describes the comparative open time performance of semi-gloss paints with and without the inventive water soluble open time enhancer. A control sample comprised the commercially available AURA® semi-gloss 5282X paint (available from Benjamin Moore & Co. of Montvale, N.J.) with no additive, Paint A. The remaining semi-gloss paints B-E were formulated with different open time extender additives at 40 pounds of additive per 100 gallons of paint. With regard to Paints A and B, the open time extender was water and a commercially available open time extender (available from Morgan Polymer Associates of Rancho Mirage, Calif.) (CA Extender), respectively. With regard to Paints C-E, Open Time Extenders 2-4 (OT 2-4), respectively, were used. All paints were tinted with 10 fluid ounces of Gennex Red oxide colorant per gallon.

TABLE 3
Open Time Formulations for Example 2
Semi-Gloss 5282X

| Formula | | | | | |
|---|---|---|---|---|---|
| Components | A | B | C | B | E |
| 100 gallon | Water | CA Extender | OT 2 | OT 3 | OT 4 |
| | amounts of components same for all paints unless noted | | | | |
| Grind | | | | | |
| Water | 45 | | | | |
| in the can | 2 | | | | |
| biocide | | | | | |
| film biocide | 2 | | | | |
| dispersant | 8 | | | | |
| anionic | 1.5 | | | | |
| surfactant | | | | | |
| defoamer | 1 | | | | |
| TiO₂ | 175 | | | | |
| extender | 30 | | | | |
| extender | 17 | | | | |
| Water | 50 | | | | |
| defoaming | 1.5 | | | | |
| surfactant | | | | | |
| anonic | 4 | | | | |
| surfactant | | | | | |
| Water | 30 | | | | |
| Letdown | | | | | |
| 803PA latex* | 475 | | | | |
| ADH | 2.5 | | | | |
| BYK-022 | 4 | | | | |
| zero-VOC | 10 | | | | |
| coalescent | | | | | |
| pH adjuster | 1.25 | | | | |
| rheology | 27.6 | 27.5 | 31.58 | 24.7 | 24.7 |
| modifier | | | | | |
| rheology | 1.5 | | | | |
| modifier | | | | | |
| rheology | 6.3 | | | | |
| modifier | | | | | |
| Water | 50 | | | | |
| Water | 40 | | | | |
| CA Extender | | 40 | | | |
| OT 2 | | | 40 | | |
| OT 3 | | | | 40 | |
| OT 4 | | | | | 40 |
| wax | 10 | | | | |
| dispersant | | | | | |
| biocide | 2 | | | | |
| Propylene | 7 | | | | |
| Glycol | | | | | |
| Water | 20.942 | | | | |
| Total | 1025.092 | | | | |
| Stormer | 100.3 | 101 | 99.1 | 94.6 | 96.4 |
| Viscosity, | | | | | |
| KU | | | | | |
| ICI Viscosity | 1.042 | 0.971 | 0.908 | 1.154 | 1.142 |

Subsequently, open time testing was conducted to measure the ability to repair marks in a wet film, as the paint dries in a constant temperature/humidity chamber (CTR) at about 77° F. and 30% relative humidity. Specifically, test paints were drawn down length wise on a black Lenta Chart to a 5 mil thickness using a DOW Latex Film Caster. Three tracks were created in the wet paint using 3 erasers on #2 pencils held one inch apart from each other using a cardboard holder containing slots to hold the pencils taut. The erasers were moved through the paint so the tracks penetrate the wet film of paint down to the black chart surface, exposing the black chart completely. A timer is then started signaling zero time for determining open time. A one-inch wide brush, Nylon/Polyester bristles Benjamin Moore 65510, was then dipped into the paint to cover ½″ of bristles, then re-dipped 2 more times and the excess paint dripped off into the paint can leaving about 0.7 to 1.0 gram paint on the brush. This brush with a wet edge of paint was then swept back and forth across the tracks ten times, staying within the one-inch boundary created by the brush. This paint brush with wet paint was applied periodically every 30 seconds until the paint obviously began to dry and exhibit dragging forces on the brush. About 0.4 to 0.6 grams of paint were removed from the brush during this sweeping action which covered up the tracks within the one-inch boundary region. Open time was determined after the paint was thoroughly dry and a visual inspection revealed at what time the edges of the eraser tracks in the paint could still be seen in the dried paint film. This signaled the end of the open time period during which a paint brush with fresh paint can cover up, hide or otherwise blend the edges (which begin to dry first) into the body of the paint film. The results of open time testing are presented below in Table 4.

TABLE 4
Open Time Improvement.

| | Open Time | Open Time | |
|---|---|---|---|
| Paint | Extender | (Minutes) | Ratio (t₂/t₁) |
| AURA 528 2X | None | 2.5 | 1.0 |
| (control) | | | |
| Paint A | Water | 2.5 | 1.0 |
| Paint B | CA Extender | 3.0 | 1.2 |
| Paint C | OT 2 | 4.0+ * | 1.6+ |
| Paint D | OT 3 | 4.0 | 1.6 |
| Paint E | OT 4 | 3.5 | 1.4 |

* Testing stopped at 4 minutes.

Table 3 shows that when an inventive water soluble open time-enhancing polymer is added to a semi-gloss paint, the paint's open time is improved over comparative semi-gloss paints comprising water or the commercially available open time extender. More particularly, the improvement in open time can be quantified by the expression T=t₂/t₁ wherein t₁ is the open time of the control paint (i.e., the paint without any additive) and t₂ is the open time of a paint with an extender. According to the present invention, the addition of an inventive water soluble open time enhancing polymer, i.e. Open Time Extenders 2-4, results in a value of T that is higher than the addition of water or the commercially available open time extender.

### Example 3

### Open Time Improvement with Improvement in Dry Film Properties

Example 3 describes the comparative open time performance of semi-gloss paints with and without inventive water soluble open time-enhancing polymers, along with characteristics of their dry film properties. Paint A, Aura™ semigloss latex 5282X did not have any open time extender, and it was used as a control. Paints F through K were each tested with water, the commercially available open time extender (CA Extender), and Open Time Extenders 1 or 5 (OT 1 or 5), which are different water soluble open time-enhancing polymers. The amount of open time extender used was adjusted for active solids. The commercially available open time extender contained about 24 percent solids, and Open Time Extenders 1 or 5 contained about 16 percent solids. Accordingly, in paints F through K, about 40 pounds of water or the commercially available open time extender were used per 100 gallons of paint, and about 60 pounds of Open Time Extenders 1 or 5 were used per 100 gallons of paint. Table 5 below presents results of testing for open time and dry film properties, i.e., brush marks, color transfer, water sensitivity, and stain removal.

TABLE 5
Open Time Formulations for Example 3
Semi-Gloss - 5282X

| Formula | F | G | H | I | J | K |
|---|---|---|---|---|---|---|
| Components | | | | | | |
| 100 Gallons | Water | CA | OT 5 | CA | Water | OT 1 |
| | | Extender | | Extender | | |
| | amounts of components same for all paints unless noted | | | | | |
| Grind | | | | | | |
| Water | 45 | | | | | |
| in can | 2 | | | | | |
| biocide | | | | | | |
| film biocide | 2 | | | | | |
| dispersant | 8 | | | | | |
| anionic | 4 | | | | | |
| surfactant | | | | | | |
| defoamer | 1.5 | | | | | |
| TiO₂ | 170 | | | | | |
| extender | 30 | | | | | |
| extender | 15 | | | | | |
| pigment | | | | | | |
| Water | 50 | | | | | |
| anionic | 4 | | | | | |
| surfactant | | | | | | |
| Water | 30 | | | | | |
| Letdown | | | | | | |
| 803PA | 475 | | | | | |
| latex* | | | | | | |
| ADH | 2.6 | | | | | |
| BYK-022 | 5 | | | | | |
| coalescent | 10 | | | | | |
| pH adjuster | 1.4 | | | | | |
| rheology | 30.47 | 33.9 | 29.14 | 34.13 | 28.7 | 28.05 |
| modifier | | | | | | |
| rheology | 1.82 | | | | | |
| modifier | | | | | | |
| rheology | 5.15 | 12.07 | 8.69 | 9.31 | 11.861 | 7.85 |
| modifier | | | | | | |
| Water | 50 | 50 | 50 | 50 | 50 | 30 |
| Water | 40 | | | | 40 | |
| CA | | 40 | | 40 | | |
| Extender | | | | | | |
| OT 5 | | | 60 | | | |
| OT 1 | | | | | | 60 |
| wax | 10 | | | | | |
| dispersant | | | | | | |
| Biocide | 2 | | | | | |
| Propylene | 6.5 | | | | | |
| Glycol | | | | | | |
| Water | 19.36 | 19.5 | 9 | 18 | 18.4 | 19 |
| Total | 1020.8 | | | | | |
| Stormer | 97.5 | 98.9 | 98.8 | 99.4 | 96 | 97.3 |
| Viscosity, | | | | | | |
| KU | | | | | | |
| ICI Viscosity | 1.26 | 1.24 | 1.31 | 1.108 | 1.28 | 1.16 |

A brush mark test was conducted. The extent of brush marks present in the final film were assessed visually for each of the test paints. After being brushed out and dried, the paints were given a numerical rating based upon their appearance: 1 (poor flow) to 5 (excellent flow).

A color transfer test was conducted as well. Felt was wrapped on a calibrated 100 g moving weight attached to a scrub machine. The felt covered calibrated weight was pulled back and forth over the surface of the panel coated with the test paint ten times by the scrub machine. The felt was then visually assessed for the amount of color transfer and assigned a numerical rating of 1 (poor) to 5 (excellent).

A water sensitivity test was also conducted. Three drops of water were placed on dried 3-mil draw-down samples for one minute. The water was wiped off and the water spot was scratched with a finger nail to check hardness of the film. A rating of 1 to 5 was assigned, where 1=soft and scratch off easy; 2=soft and scratched off with some force; 3=medium soft and scratch some portions off with force; 4=hard and scratch slightly off with strong force; and 5=hard and cannot scratch off.

Stain removal testing was also conducted in accordance with ASTM D4828. The samples were drawn down on a black vinyl chart and allowed to dry for 7 days in a constant temperature and humidity room at 77° F. and 30% relative humidity. Stains, TTP-29 (ASTM D3450 black stain) and litter (ASTM 2198), were applied to the film and allowed to stand for 2 hours. Excess stain was gently wiped using laboratory tissue, and then placed upon a Washability tester fitted with a sponge. The sponge was saturated with a 1% solution of Fantastik™ (S.C. Johnson & Son, Inc.) in water, and the film subjected to a scrub cycle until stain was removed.

TABLE 6
Open Time Improvement.

| | | Open | | | | | |
|---|---|---|---|---|---|---|---|
| | Open Time | Time | Ratio | Brush | Color | Water | Stain |
| Paint | Extender | (Min) | (t₂/t₁) | Marks* | Transfer* | Sensitivity* | Removal** |
| Control | None | 2.5 | 1.0 | 4 | 5 | 2 | 6/1 |
| F | Water | 2.5 | 1.0 | 4 | 3 | 4 | 6/100+ |
| G | CA Extender | 2.0 | 0.8 | 5 | 4 | 4.5 | 8/100+ |
| H | OT 5 | 3.0 | 1.2 | 5 | 4.5 | 4 | 9/3 |
| I | CA Extender | 2.5 | 1.0 | 3 | 4 | 1 | 6/50 |
| J | Water | 2.5 | 1.0 | 4 | 4.5 | 4 | 5/29 |
| K | OT 1 | 3.0 | 1.2 | 5 | 5 | 4 | 6/4 |

*Rating Scale 1 to 5 with 5 being the best rating. Coatings dried for 7 days before testing.
**Number of scrub cycles needed to remove stain. The first number is for TTP stain, and the second number is for litter stain.

Experimental Open Time Extenders 1 and 5 yielded the longest open times of about 3.0 minutes, the smoothest coatings (ratings of 5) with the least evidence of brush marks, the least amount of color transfer (ratings of 5), very good resistance to scratching after exposure to water (water sensitivity ratings of 4), and easy stain removal with complete removal of both types of stain in under 10 scrub cycles.

On an active solids basis, the experimental Open Time Extenders 1 and 5 were more effective at extending the open time of a semi-gloss paint than the commercially available open time extender.

### Example 4

### Real World Testing of Open Time Extender

A real world test of Paints I-J, noted above in Example 3, was conducted. Three separate individuals, Individuals 1-3, were asked to paint one panel and the surroundings on a 6-panel factory primed wood door obtained from Home Depot™ with a sample of paint. The individuals were provided with a control (Aura control) and Paints I-J in a blinded fashion. The doors were painted in an environment having a temperature of 69.4° F. and a relative humidity of 22%. Each individual commented on the brushability of each of the paint samples they used.

Further, after allowing the doors to dry a day, each of the individuals was asked to assess the dry appearance of the door panels they painted as well as the door panels painted by the other individuals. The dry appearance was rated on a scale of 1 (best, smooth, absence of brush marks, and uniformity of paint) to 4 (worst, rough, clear brush marks, unevenness of the paint). The results of this real world testing are provided in Table 7 below.

TABLE 7
Results of Real World Testing
Test 1: Brushability Test

| Tester | Aura Control | Paint I | Paint J | Paint K |
|---|---|---|---|---|
| Individual | Setting up almost | Cutting back in | Similar to Paint I | Least build up at top |
| 1 | immediately | left a line not a | for cutting back in | of panel, so blended |
| | | big difference | | in better. May be a |
| | | vs. control. | | bit better for open |
| | | Similar to control | | time. |
| | | but could feather | | |
| | | in better | | |
| Individual | Setting up almost | Similar to | Slightly better than | Better open time. |
| 2 | immediately. | control | Paint I for drag, | |
| | Goes on | | more like control. | |
| | smoother than | | | |
| | Paint I. | | | |
| Individual | Best, not drying | Waited 1 minute | Similar to Paint I. | Better than Paints I |
| 3 | fast. | to go back into it. | A little easier initially, | and J. Hard to cut |
| | | Cannot-drag, stiff. | but still draggy. Waited | back in after 1 |
| | | | 1 minute slightly | minute. |
| | | | better than Paint I. | |

TEST 2: Next Day Rating of Dry Appearance

| Door | | | | | |
|---|---|---|---|---|---|
| Evaluated | Evaluator | Aura Control | Paint I | Paint J | Paint K |
| Individual | Individual 2 | 3 | 2 | 4 | 1 |
| 1's | Individual 3 | 3 | 2 | 4 | 1 |
| | Individual 1 | 4 | 2.5 | 2.5 | 1 |
| Individual | Individual 2 | 3 | 4 | 2 | 1 |
| 2's | Individual 3 | 3 | 4 | 2 | 1 |
| | Individual 1 | 4 | 3 | 2 | 1 |
| Individual | Individual 2 | 3.5 | 2 | 3.5 | 1 |
| 3's | Individual 3 | 3.5 | 2 | 3.5 | 1 |
| | Individual 1 | Not Rated | Not Rated | Not Rated | Not Rated |

As noted in Table 7 above, Paint K received favorable evaluation of its open time and dry appearance characteristics from the evaluators. The evaluators further commented on the dry appearance of Paint K noting that it exhibited the best uniformity and that the ridges on the brush marks appeared to be more rounded than the other paint samples. This is particularly impressive given that the paints were applied in a relatively warm and dry environment which typically results in a reduction of the open time of paint.

These real world results correlate well with the laboratory results noted above in Table 6 of Example 3. In Table 6, the control exhibited an open time of 2.5 minutes and a dry appearance rating of 4 (5=best, 1=worst). Paints I and J had open times of 2.5 minutes and dry appearance ratings of 3 and 4, respectively in Table 6, and received similar ratings in real-world test as noted in Table 7. In both Table 6 and Table 7, Paint K received the best evaluation of its open time and dry appearance, 3 minutes open time and dry appearance rating of 5 in Table 6 and noted better open time and dry appearance rating of 1 (1=best, 5=worst) in table 7).

While various embodiments of the present invention have been described above, it should be understood that they have been presented by way of illustration and example only, and not limitation. It will be apparent to persons skilled in the relevant art that various changes in form and detail can be made therein without departing from the spirit and scope of the invention.

Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment.

1. An open time extender adapted to be admixed with an architectural coating composition to extend the open time of said architectural coating composition, said open time extender comprising:
neutralized water soluble polymers comprised of hydrophilic, hydrophobic and crosslinking monomers, wherein the crosslinking monomer is selected to be crosslinkable with said open time extender, another open time extender having a crosslinkable monomer, or said architectural coating composition;
at least one crosslinking agent;
and water,
wherein the total solid content of the open time extender is less than about 20% by weight.

2. The open time extender of claim 1, wherein the hydrophilic monomer is selected from a group consisting of acrylic acid (AA), methacrylic acid (MAA), itaconic acid (IA), hydroxyethyl acrylate (HEA), hydroxyethyl methacrylate, (HEMA), acetoacetoxyethyl methacrylate (AAEM), diacetone acrylamide (DAAM), vinyl acetate (VA), or copolymers and combinations thereof.

3. The water soluble open time extender of claim 2, wherein the hydrophilic monomer is acrylic acid (AA).

4. The water soluble open time extender of claim 3, wherein the hydrophilic monomer also includes diacetone acrylamide (DAAM).

5. The open time extender of claim 1, wherein the hydrophobic monomer is selected from a group consisting of vinyl 2-ethylhexanoate, vinyl laurate, vinyl stearate, vinyl alkyl or aryl ethers with (C₉-C₃₀) alkyl groups such as stearyl vinyl ether; (C₄-C₃₀) alkyl esters of (meth-)acrylic acid, such as butyl(meth)acrylate, hexyl(meth)acrylate, heptyl(meth)acrylate, octyl(meth)acrylate, isooctyl acrylate, isononyl acrylate, decyl(meth)acrylate, isodecyl(meth)acrylate, dodecyl(meth)acrylate, 2-ethylhexyl(meth)acrylate, benzyl(meth)acrylate, lauryl(meth)acrylate, oleyl(meth)acrylate, palmityl(meth)acrylate, and stearyl(meth)acrylate; unsaturated vinyl esters of (meth)acrylic acid such as those derived from fatty acids and fatty alcohols; monomers derived from cholesterol; olefinic monomers such as 1-butene, 2-butene, 1-pentene, 1-hexene, 1-octene, isobutylene and isoprene; or copolymers and combinations thereof.

6. The open time extender of claim 1, wherein the crosslinkable monomer is selected from the group consisting of diacetone acrylamide (DAAM), monoalkoxydialkyl vinyl silanes, dialkoxyalkyl vinyl silanes, trialkoxy vinyl silanes, monoalkoxy acrylic silanes, dialkoxy acrylic silanes, trialkoxy acrylic silanes, trialkoxy methacrylic silanes, monoalkoxy epoxy silanes, dialkoxy epoxy silanes or trialkoxy epoxy silanes, and copolymers and combinations thereof.

7. The open time extender of claim 1, wherein the crosslinking agent comprises at least one crosslinkable functional selected from the group consisting of epoxies, silanes, silane ethers, amines, hydroxyls, carboxylic acids, carboxylates, amides, urethanes, thiourethanes, ureas, thioureas, isocyanates, isothiocyanates, acid halides, aldehydes, anhydrides, and combinations thereof.

8. The open time extender of claim 7, wherein the cross linking agent is adipic dihydrazide (ADH).

9. The open time extender of claim 1 wherein the neutralized water soluble polymers are neutralized with ammonium hydroxide.

10. The open time extender of claim 1, wherein the neutralized water soluble polymers are neutralized in situ when they are added to the architectural coating.

11. The open time extender of claim 1, wherein the total solid content of the open time extender is less than about 25%.

12. The open time extender of claim 1, wherein the total solid content of the open time extender is less than about 20%.

13. The open time extender of claim 1, wherein the open time extender is added to an architectural coating composition.

14. The open time extender of claim 13, wherein the open time extender is less than 10% weight of the architectural coating composition.

15. The open time extender of claim 14, wherein the open time extender is less than 7.5% weight of the architectural coating composition.

16. The open time extender of claim 15, wherein the open time extender is less than 5% weight of the architectural coating composition.

17. The open time extender of claim 1 further comprising at least one of an open time agent, pH adjustor, a second crosslinking agent having at least one crosslinkable functional group, a preservative, a biocide and a defoamer.

18. The open time extender of claim 1, wherein the architectural coating composition is a paint composition.

19. The open time extender of claim 1, wherein the at least one crosslinkable monomer can crosslink to itself, to the architectural coating composition or any combination thereof at ambient conditions.

20. The open time extender of claim 1, wherein the open time extender has a weight average molecular weight of less than about 25,000 Daltons.

21. The open time extender of claim 20, wherein the open time extender has a weight average molecular weight of less than about 20,000 Daltons.

22. The open time extender of claim 21, wherein the open time extender has a weight average molecular weight of about 11,000 Daltons.

23. The open time extender of claim 1, wherein the open time extender has a weight average molecular weight of between about 5,000 Daltons to about 15,000 Daltons.

24. The open time extender of claim 1, wherein the open time extender has a number average molecular weight of less than 10,000 Daltons.

25. The open time extender of claim 24, wherein the open time extender has a number average molecular weight of less than 7,500 Daltons.

26. The open time extender of claim 1, wherein the open time extender has a number average molecular weight of between about 3,000 to about 6,000 Daltons.

27. The open time extender of claim 1, wherein the open time extender has a polydispersity index of less than about 5.

28. The open time extender of claim 27, wherein the polydispersity index of the open time extender is less than about 4.

29. The open time extender of claim 19, wherein the crosslinking monomer is crosslinkable with a latex of the architectural coating.

30. The open time extender of claim 19, wherein the crosslinking monomer is crosslinkable with an additive of the architectural coating.
